(19) United States
(12) Patent Application Publication
(10) Pub. No.: US 2012/0162215 A1
(43) Pub. Date: Jun. 28, 2012

(54) APPARATUS AND METHOD FOR GENERATING TEXTURE OF THREE-DIMENSIONAL RECONSTRUCTED OBJECT DEPENDING ON RESOLUTION LEVEL OF TWO-DIMENSIONAL IMAGE

(75) Inventors: Young-Mi CHA, Busan (KR); Chang-Woo Chu, Daejeon (KR); Il-Kyu Park, Daejeon (KR); Bon-Ki Koo, Daejeon (KR)

(73) Assignee: Electronics and Telecommunications Research Institute, Daejeon (KR)

(21) Appl. No.: 13/333,914

(22) Filed: Dec. 21, 2011

(30) Foreign Application Priority Data
Dec. 22, 2010 (KR) 10-2010-0132878
Mar. 16, 2011 (KR) 10-2011-0023508

(51) Int. Cl. G06T 15/04

(52) U.S. Cl. 345/419

(57) ABSTRACT

The present invention relates to an apparatus and method for generating a texture of a 3D reconstructed object depending on a resolution level of a 2D image. The apparatus includes a 3D object reconstruction unit for extracting, from images captured from at least two areas located at different distances, information about a 3D object and information about cameras, and then reconstructing the 3D object. A resolution calculation unit measures size of a space area, covered by one pixel of each of the images in a photorealistic image of the 3D object, and then calculates resolutions of the images. A texture generation unit generates textures for respective levels corresponding to classified images by using the images classified according to resolution level. A rendering unit selects a texture for a relevant level depending on a size of the 3D object on a screen, and then renders the selected texture.

### CROSS REFERENCE TO RELATED APPLICATION

This application claims the benefit of Korean Patent Application No. 10-2010-0132878, filed on Dec. 22, 2010, and Korean Patent Application No. 10-2011-0023508, filed on Mar. 16, 2011, which are hereby incorporated by reference in their entirety into this application.

### BACKGROUND OF THE INVENTION

1. Technical Field

The present invention relates generally to an apparatus and method for generating the texture of a three-dimensional (3D) reconstructed object depending on the resolution level of a two-dimensional (2D) image and, more particularly, to an apparatus and method for generating the texture of a 3D reconstructed object depending on the resolution level of a 2D image, which generate textures for respective levels depending on the size of an area, covered by each pixel of each of 2D images having various sizes and resolutions, in real space or in the space of the 3D reconstructed object.

2. Description of the Related Art

In the field of three-dimensional (3D) computer graphics, a texture mapping technique for applying two dimensional (2D) images to a polygon rendered in three-dimensions is used to assign reality to the polygon.

For texture mapping, 2D images to be applied to the respective faces of a 3D model must be produced. Generally, such a 2D image is either produced by a designer or produced using a method that applies a partial region of a photorealistic image to a model.

In this way, when rendering is performed using a texture, there may be a large difference between the size of the texture and the size of the model that is rendered on a screen.

By way of example, when the size of the rendered model is greater than that of the texture, a phenomenon in which the pixels of the texture are exposed and are viewed as blocks may occur. Further, the texture is so small that aliasing may result.

### SUMMARY OF THE INVENTION

Accordingly, the present invention has been made keeping in mind the above problems occurring in the prior art, and an object of the present invention is to provide an apparatus and method for generating the texture of a 3D reconstructed object depending on the resolution level of a 2D image, which enable automatic photorealistic texturing for performing realistic and detailed representation using images having various sizes and resolutions.

Another object of the present invention is to provide an apparatus and method for generating the texture of a 3D reconstructed object depending on the resolution level of a 2D image, which divide images (aerial images, images captured by a vehicle, images captured by a user, etc.), which cover areas of different sizes per pixel in real space, into different levels depending on the size of a representation area per pixel, and which generate textures for the respective levels, thus minimizing problems related to the blurring of textures and enabling natural details to be represented when the display of the 3D reconstructed object is zoomed in or out.

In accordance with an aspect of the present invention to accomplish the above objects, there is provided an apparatus for generating a texture of a three-dimensional (3D) reconstructed object depending on a resolution level of a two-dimensional (2D) image, including a 3D object reconstruction unit for extracting, from images captured from at least two areas located at different distances, information about a 3D object and information about cameras that capture the images, and then reconstructing the 3D object included in the images, a resolution calculation unit for calculating resolutions of the images by measuring a size of a space area, covered by one pixel of each of the images in a photorealistic image of the 3D object, a texture generation unit for generating textures for respective levels corresponding to classified images by using the images classified according to resolution level, and a rendering unit for selecting a texture for a relevant level depending on a size of the 3D object on a screen, and then rendering the selected texture.

Preferably, the apparatus may further include a level classification unit for classifying the images according to resolution level, and classifying the textures according to level of corresponding images.

Preferably, the level classification unit may classify the resolutions into k levels by applying information about the resolutions of the images to a k-means algorithm.

Preferably, the texture generation unit may generate mipmaps for respective levels using the textures classified according to level of the images.

Preferably, the texture generation unit may generate the textures for each face of the 3D object.

Preferably, the 3D object reconstruction unit may extract, from the images, at least one of location information, angle information and motion information of the cameras which capture the images, and perform camera calibration on the images.

Preferably, the apparatus may further include a storage unit for individually storing the images classified according to resolution level, and the textures for respective levels corresponding to the classified images.

In accordance with another aspect of the present invention to accomplish the above objects, there is provided a method of generating a texture of a three-dimensional (3D) object depending on a resolution level of a two-dimensional (2D) image, including extracting, from images captured from at least two areas located at different distances, information about a 3D object and information about cameras that capture the images, and then reconstructing the 3D object included in the images, calculating resolutions of the images by measuring a size of a space area, covered by one pixel of each of the images in a photorealistic image of the 3D object, generating textures for respective levels corresponding to classified images by using the images classified according to resolution level, and selecting a texture for a relevant level depending on a size of the 3D object on a screen, and then rendering the selected texture.

Preferably, the method may further include classifying the resolutions into k levels by applying information about the resolutions of the images to a k-means algorithm.

Preferably, the generating the textures may generate the textures for each face of the 3D object.

Preferably, the method may further include classifying the textures to correspond to resolution levels of the images.

Preferably, the method may further include generating mipmaps for respective levels using the textures classified according to resolution levels of the images.

Preferably, the reconstructing the 3D object may include extracting, from the images, at least one of location information, angle information and motion information of the cameras which capture the images, and performing camera calibration on the images.

Preferably, the method may further include individually storing the images classified according to resolution level, and individually storing the textures for respective levels corresponding to the classified images.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an image acquisition operation applied to a texture generation apparatus according to the present invention;

FIG. 2 is a block diagram showing the construction of the texture generation apparatus according to the present invention;

FIG. 3 is a block diagram showing the detailed construction of a storage unit according to the present invention;

FIG. 4 is a block diagram showing the detailed construction of a 3D object reconstruction unit according to the present invention;

FIG. 5 is a diagram illustrating a resolution calculation operation performed by the texture generation apparatus according to the present invention;

FIG. 6 is a diagram illustrating a texture generation operation performed by a texture generation unit according to the present invention; and

FIG. 7 is a flowchart showing the operating flow of a texture generation method according to the present invention.

### DESCRIPTION OF THE PREFERRED EMBODIMENTS

Reference now should be made to the drawings, in which the same reference numerals are used throughout the different drawings to designate the same or similar components.

Hereinafter, embodiments of the present invention will be described in detail with reference to the attached drawings.

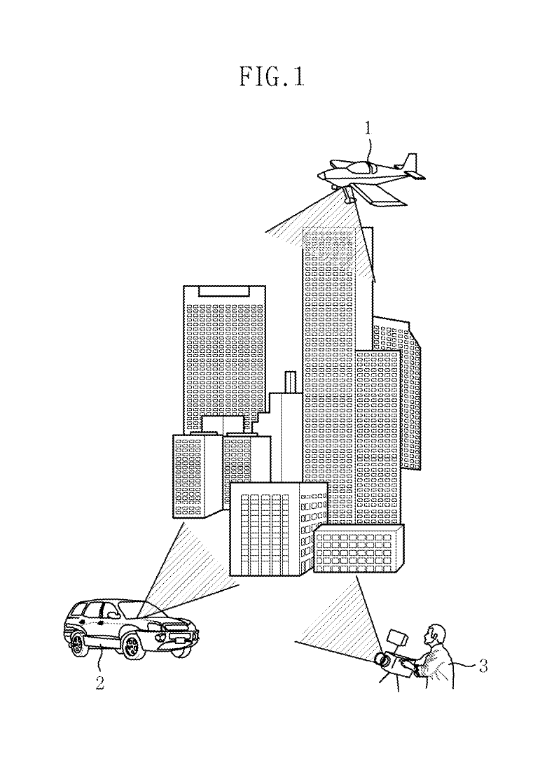

FIG. 1 is a diagram illustrating an image acquisition operation applied to a texture generation apparatus according to the present invention.

As shown in FIG. 1, images that are input to reconstruct a 3D object in the present invention can be collected using various methods. As an example, such an image may be an aerial image obtained by capturing a picture of a large area from an aircraft 1, or an image captured using a camera mounted on a vehicle 2 or the like. Further, the image may be an image personally captured by a user 3 at short range.

Among images collected using various methods in this way, an area covered by each pixel to represent the real space, that is, the resolution, differs.

Therefore, it is preferable to generate textures suitable for the respective resolution levels using images having different resolutions.

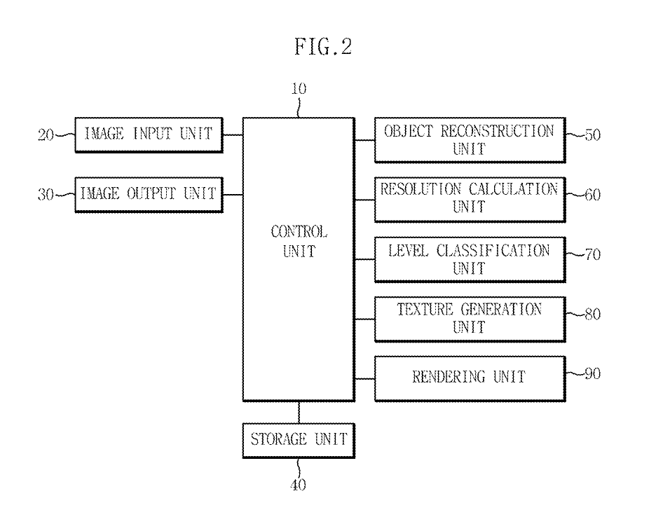

In this regard, the construction of the present invention that generates textures for respective resolution levels will be described in detail with reference to FIG. 2.

FIG. 2 is a block diagram showing the construction of the texture generation apparatus according to the present invention.

As shown in FIG. 2, the texture generation apparatus according to the present invention includes a control unit 10, an image input unit 20, an image output unit 30, a storage unit 40, a 3D object reconstruction unit 50, a resolution calculation unit 60, a level classification unit 70, a texture generation unit 80, and a rendering unit 90. Here, the control unit 10 controls the operations of the individual units of the texture generation apparatus.

Meanwhile, the image input unit 20 inputs a plurality of images required to generate textures in the texture generation apparatus. In this case, the images input by the image input unit 20 may be aerial images, images captured by a vehicle, and images personally captured by a user, as in the case of the embodiment of FIG. 1.

The image output unit 30 is a means for outputting the textures generated by the texture generation apparatus.

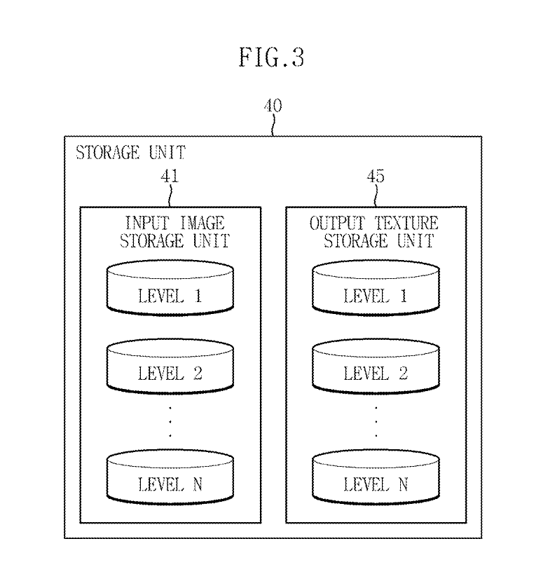

The storage unit 40 stores the plurality of images input by the image input unit 20. In this case, the storage unit 40 may store the plurality of images with the images classified according to resolution level. Further, the storage unit 40 stores the textures generated using the plurality of images. Of course, the storage unit 40 may store the textures with the textures classified according to level. The detailed construction of the storage unit 40 will be described with reference to an embodiment of FIG. 3.

The 3D object reconstruction unit 50 extracts information about a 3D object and information about cameras that capture the images by using the images stored in the storage unit 40, and reconstructs the 3D object using the pieces of extracted information. In the present invention, the 3D object is reconstructed using an existing 3D object reconstruction method.

The resolution calculation unit 60 calculates the resolution of each of the images input by the image input unit 20. In this case, the resolution calculation unit 60 measures the size of a space area covered by each pixel of a relevant image with respect to a photorealistic image of the reconstructed 3D object.

For example, when a 3D object is reconstructed using an aerial image, a photorealistic image captured by a vehicle, and an image captured by a user using a typical camera, as shown in FIG. 1, and then the resolution of the reconstructed 3D object is extracted, the resolution of the aerial image is about 50×50, which means that a 3D reconstructed area covered by one pixel is 50×50. Further, the resolution of the image captured by the vehicle on the ground is about 30×30, and the resolution of the image captured by the user on the ground is about 5×5.

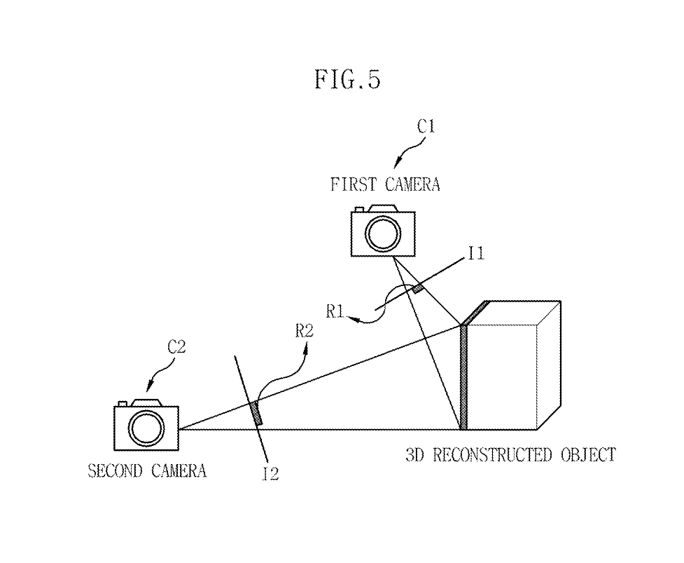

A detailed embodiment of a procedure in which the resolution calculation unit 60 calculates the resolutions of respective images will be described later with reference to FIG. 5.

The level classification unit 70 classifies the images according to the level of resolution by comparing the resolutions of the images calculated by the resolution calculation unit 60. In this case, the classified images are stored for respective resolution levels in the storage unit 40.

For example, when it is desired to classify the images into k levels, the level classification unit 70 classifies the levels of the resolution into k levels by applying the calculated resolutions to a classification algorithm such as a k-means algorithm.

In this case, the level classification unit 70 may automatically designate the number of classification levels, and classify the resolution levels according to the number of classification levels that is manually input.

The texture generation unit 80 generates textures using the individual images that are classified according to level and stored in the storage unit 40. In this regard, the texture generation unit 80 generates textures for each of the faces of the 3D reconstructed object using images corresponding to the respective levels.

Here, the texture generation unit 80 generates textures for respective levels using the concept of a mipmap. In other words, the texture generation unit 80 configures mipmaps for respective levels using the textures, and stores the configured mipmaps into the output texture storage unit 45.

Meanwhile, the level classification unit 70 classifies the textures, which are generated to correspond to the respective levels of the images, according to level. Similarly, the classified textures are stored for respective levels in the storage unit 40.

The rendering unit 90 selects a texture for a relevant level depending on the size of the object on the screen, from among the textures stored in the storage unit 40, and then renders the selected texture. In this case, the rendering unit 90 selects a texture on a level basis according to the distance to the 3D reconstructed object and uses the selected texture upon a zoom-in or zoom-out function.

Therefore, the texture generation apparatus according to the present invention can minimize the problem of blurring and can represent natural details when a zoom-in or zoom-out function is performed.

FIG. 3 is a block diagram showing the detailed construction of the storage unit according to the present invention.

As shown in FIG. 3, the storage unit 40 according to the present invention includes an input image storage unit 41 and an output texture storage unit 45.

The input image storage unit 41 stores images input by the image input unit. In this case, the input image storage unit 41 includes storage areas for respective levels. For example, the input image storage unit 41 individually includes storage areas corresponding to level 1, level 2, . . . , level N.

Therefore, the images input by the image input unit are stored in the storage areas corresponding to respective levels. In this case, the images classified according to level may be managed in such a way that the levels of the images are set to tags.

The output texture storage unit 45 stores the textures generated by the texture generation unit 80. Here, the output texture storage unit 45 includes storage areas for respective levels to correspond to the input image storage unit 41. For example, the output texture storage unit 45 individually includes storage areas corresponding to level 1, level 2, . . . , level N.

Therefore, the textures generated by the texture generation unit are stored in the storage areas corresponding to the levels of the images used to generate relevant textures. In other words, a texture generated using images corresponding to level 1 may be level 1 and a texture generated using images corresponding to level 2 may be level 2.

In this case, the textures classified according to level may be managed in such a way that the levels of the textures are set to tags.

The term ‘level’ stated herein denotes each level of resolution calculated by the resolution calculation unit. For example, level 1 may be the level at which resolution is about 50×50, level 2 may be the level at which resolution is about 30×30, and level 3 may be the level at which resolution is about 5×5.

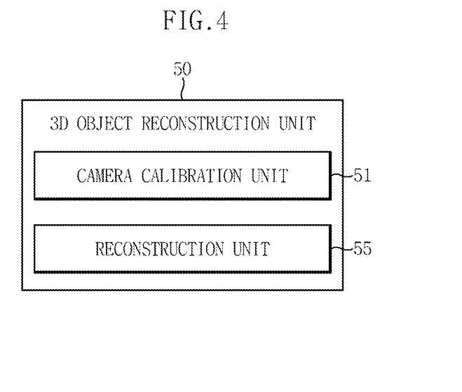

FIG. 4 is a block diagram showing the detailed construction of the 3D object reconstruction unit according to the present invention.

As shown in FIG. 4, the 3D object reconstruction unit 50 according to the present invention includes a camera calibration unit 51 and a reconstruction unit 55.

The camera calibration unit 51 performs camera calibration on the images input by the image input unit. Here, the term ‘camera calibration’ denotes an operation of extracting information such as the locations, angles or motions of cameras from the 2D images, and then calibrating the 2D images.

The reconstruction unit 55 reconstructs a 3D object using the 2D images on which camera calibration has been performed. Here, the reconstruction unit 55 can reconstruct the 3D object using an existing 3D reconstruction method that is generally used. Therefore, a description of the detailed operation of reconstructing the 3D object will not be given. In this case, the reconstruction unit 55 may acquire information about the cameras and also information about 3D reconstructed data during the procedure of reconstructing the 3D object.

FIG. 5 is a diagram illustrating the resolution calculation operation performed by the texture generation apparatus according to the present invention.

As shown in FIG. 5, the resolution calculation unit calculates the size of the space area of the 3D reconstructed object covered by each pixel in each of the images, that is, resolution, by using the camera information and the 3D reconstructed data information acquired by the 3D object reconstruction unit.

In this case, the resolution calculation unit performs reprojection on the capturing area of each camera C1, C2 obtained by camera calibration on the basis of a specific area of the 3D reconstructed object. Further, the resolution calculation unit calculates pixels occupied by the reprojected area R1, R2 in a photorealistic image I1, I2 of the relevant camera C1, C2.

Here, the term ‘reprojection’ denotes an operation of projecting one point on the 3D reconstructed object on a photorealistic image I1, I2 using information about the location, direction, and focal length of the camera C1, C2 that have been obtained by camera calibration.

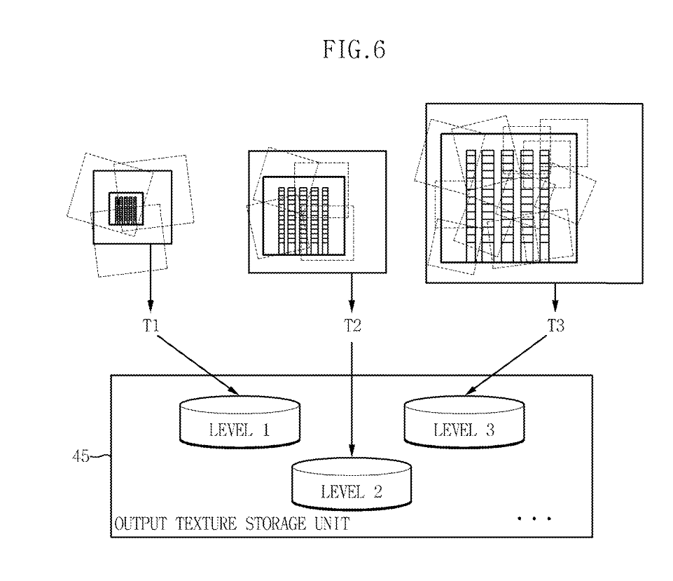

FIG. 6 is a diagram illustrating the texture generation operation performed by the texture generation unit according to the present invention.

As shown in FIG. 6, the output texture storage unit 45 individually stores textures classified according to level. For example, it is assumed that texture T1 for aerial images having a resolution of 50×50 is stored in level 1. Further, it is assumed that texture T2 for images, which are captured by a vehicle and have a resolution of 30×30, is stored in level 2. Furthermore, it is assumed that texture T3 for images, which are captured by the user and have a resolution of 5×5, is stored in level 3.

In this case, as shown in FIG. 6, the texture generation unit generates textures for respective levels using the concept of a mipmap. In other words, the texture generation unit configures mipmaps for respective levels using the textures, and stores the mipmaps in the output texture storage unit 45.

Therefore, the rendering unit selects a texture for a suitable level depending on the size of the object on the screen at the time of rendering the 3D object and then renders the selected texture.

The operating flow of the present invention having the above construction will be described below.

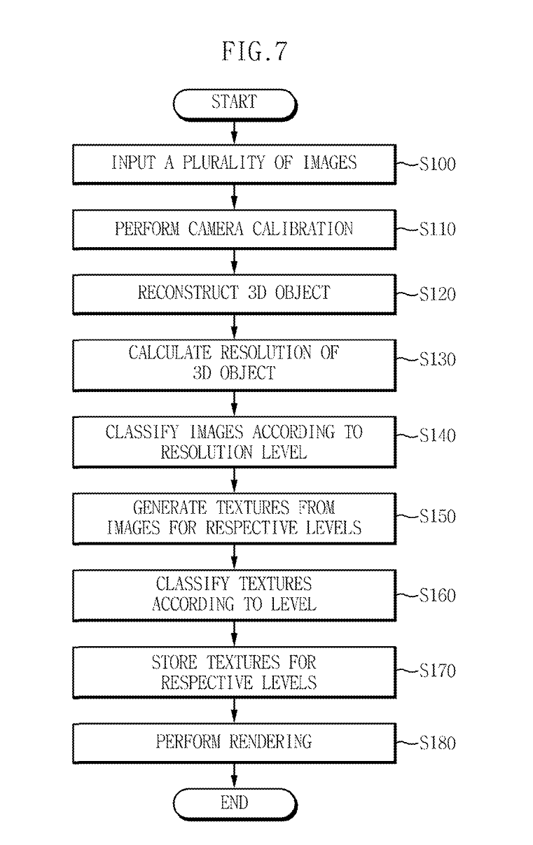

FIG. 7 is a flowchart showing the operating flow of a texture generation method according to the present invention.

As shown in FIG. 7, when a plurality of images (for example, aerial images, images captured by a vehicle, images personally captured by a user, etc.) are input at step S100, the texture generation apparatus performs camera calibration on the plurality of input images at step S110. Here, camera calibration denotes an operation of extracting information, such as the locations, angles or motions of cameras, from the 2D images and then calibrating the relevant 2D images.

Thereafter, the texture generation apparatus reconstructs a 3D object using the 2D images on which camera calibration has been performed at step S120.

Meanwhile, the texture generation apparatus calculates the size of a space area, covered by each pixel in each of the plurality of images with respect to a photorealistic image of the 3D reconstructed object, that is, the resolution, at step S130. In this case, the texture generation apparatus classifies the images according to the level of the resolution, calculated at step S130, at step S140. The texture generation apparatus may classify the images according to the resolution level using a classification algorithm such as a k-means algorithm. The classified images are stored for respective resolution levels in the storage unit.

The texture generation apparatus generates textures from the images for respective levels classified at step S140 at step S150. In this case, the texture generation apparatus generates the textures for each of the faces of the reconstructed 3D object using images corresponding to the respective levels.

Similarly, the texture generation apparatus classifies the textures generated at step S150 according to level at step S160, and then stores the classified textures for respective levels in the storage unit at step S170.

Thereafter, the texture generation apparatus selects a texture corresponding to a specific level, from among the textures which are stored for respective levels in the storage unit, depending on the distance to the 3D object, and renders the selected texture at step S180.

As described above, although the apparatus and method for generating the texture of a 3D reconstructed object depending on the resolution level of a 2D image according to the present invention have been described with reference to the illustrated drawings, the present invention is not limited by the embodiments and drawings disclosed in the present specification, and can be modified in various manners without departing from the spirit and scope of the present invention.

According to the present invention, various images having different resolutions are divided into levels depending on an area covered by each pixel to represent real space in each of the images, and textures for respective levels are generated, so that there is an advantage in that the problems of aliasing and blurring occurring during the rendering of a 3D object can be solved.

What is claimed is:

1. An apparatus for generating a texture of a three-dimensional (3D) reconstructed object depending on a resolution level of a two-dimensional (2D) image, comprising:
a 3D object reconstruction unit for extracting, from images captured from at least two areas located at different distances, information about a 3D object and information about cameras that capture the images, and then reconstructing the 3D object included in the images;
a resolution calculation unit for calculating resolutions of the images by measuring a size of a space area, covered by one pixel of each of the images in a photorealistic image of the 3D object;
a texture generation unit for generating textures for respective levels corresponding to classified images by using the images classified according to resolution level; and
a rendering unit for selecting a texture for a relevant level depending on a size of the 3D object on a screen, and then rendering the selected texture.

2. The apparatus of claim 1, further comprising a level classification unit for classifying the images according to resolution level, and classifying the textures according to level of corresponding images.

3. The apparatus of claim 2, wherein the level classification unit classifies the resolutions into k levels by applying information about the resolutions of the images to a k-means algorithm.

4. The apparatus of claim 2, wherein the texture generation unit generates mipmaps for respective levels using the textures classified according to level of the images.

5. The apparatus of claim 1, wherein the texture generation unit generates the textures for each face of the 3D object.

6. The apparatus of claim 1, wherein the 3D object reconstruction unit extracts, from the images, at least one of location information, angle information and motion information of the cameras which capture the images, and performs camera calibration on the images.

7. The apparatus of claim 1, further comprising a storage unit for individually storing the images classified according to resolution level, and the textures for respective levels corresponding to the classified images.

8. A method of generating a texture of a three-dimensional (3D) object depending on a resolution level of a two-dimensional (2D) image, comprising:
extracting, from images captured from at least two areas located at different distances, information about a 3D object and information about cameras that capture the images, and then reconstructing the 3D object included in the images;
calculating resolutions of the images by measuring a size of a space area, covered by one pixel of each of the images in a photorealistic image of the 3D object;
generating textures for respective levels corresponding to classified images by using the images classified according to resolution level; and
selecting a texture for a relevant level depending on a size of the 3D object on a screen, and then rendering the selected texture.

9. The method of claim 8, further comprising classifying the resolutions into k levels by applying information about the resolutions of the images to a k-means algorithm.

10. The method of claim 8, wherein the generating the textures generates the textures for each face of the 3D object.

11. The method of claim 8, further comprising classifying the textures to correspond to resolution levels of the images.

12. The method of claim 11, further comprising generating mipmaps for respective levels using the textures classified according to resolution levels of the images.

13. The method of claim 8, wherein the reconstructing the 3D object comprises extracting, from the images, at least one of location information, angle information and motion information of the cameras which capture the images, and performing camera calibration on the images.

14. The method of claim 8, further comprising:
individually storing the images classified according to resolution level; and
individually storing the textures for respective levels corresponding to the classified images.
